(19) United States
(12) Patent Application Publication
(10) Pub. No.: US 2010/0329252 A1
(43) Pub. Date: Dec. 30, 2010

(54) Method and Apparatus for Enabling Multicast Route Leaking Between VRFs in Different VPNs

(75) Inventors: Vijay Mulamalla, Nashua, NH (US); Ganesh Nakhawa, Westford, MA (US); Bakul Khanna, Lexington, MA (US)

Correspondence Address: Anderson Gorecki & Manaras, LLP;Attn: John C. Gorecki, P.O BOX 553, CARLISLE, MA, 01741, US

(73) Assignee: Nortel Networks Limited, St. Laurent (CA)

(21) Appl. No.: 12/492,577

(22) Filed: Jun. 26, 2009

(51) Int. Cl. H04L 12/56

(52) U.S. Cl. 370/390

(57) ABSTRACT

Multicast route leaking between VRFs in different VPNs enables receivers in different VPNs to subscribe to the same IP multicast so that an efficient IP multicast distribution tree can be built to include subscribers in multiple VPNs. VRFs are administratively configured to implement multicast route leaking and each such configured VRF brings up an internal connectionless IP interface. The VRFs then enable the multicast routing protocol (e.g. PIM) on the internal IP interface to establish PIM neighborships with each other. When a VRF receives an IGMP join from a receiver, it uses PIM to join the receiver to the multicast over the internal IP interface. This enables receivers outside of a VPN but associated with VRFs that are co-located on the same PE to join multicasts established within the VPN so that separate multicast distribution trees are not required for each VPN.

### TECHNICAL FIELD

The present invention relates to communication networks and, more particularly, to a method and apparatus for enabling multicast route leaking between VRFs in different VPNs.

### BACKGROUND

Data communication networks may include various computers, servers, nodes, routers, switches, bridges, hubs, proxies, and other network devices coupled together and configured to pass data to one another. These devices will be referred to herein as “network elements.” Data is communicated through the data communication network by passing protocol data units, such as data frames, packets, cells, or segments, between the network elements by utilizing one or more communication links. A particular protocol data unit may be handled by multiple network elements and cross multiple communication links as it travels between its source and its destination over the network.

The various network elements on the communication network communicate with each other using predefined sets of rules, referred to herein as protocols. Different protocols are used to govern different aspects of the communication, such as how signals should be formed for transmission between network elements, various aspects of what the protocol data units should look like, how packets should be handled or routed through the network by the network elements, and how information associated with routing information should be exchanged between the network elements.

A Virtual Private Network (VPN) may be formed by securing communications between two or more networks or network elements to form a VPN tunnel, such as by encrypting or encapsulating transmissions between the networks or network elements. Using VPN tunnels enables information to be exchanged securely between geographically dispersed sites without obtaining dedicated resources through the network.

To enable devices on one VPN site to communicate with devices on another VPN site via the VPN tunnel, it is necessary to exchange routing information between the two VPN sites. Likewise, as network elements are added and removed from the networks, or as problems are encountered and fixed in the networks, the routing tables need to be updated and advertised to the other participating sites in the VPN.

There are several commonly utilized methods of establishing VPN tunnels on a network. One common way of establishing VPNs is to configure the VPN at the Provider Edge (PE) network elements to allow the service provider to provision VPN services on behalf of the customer. Internet Engineering Task Force (IETF) Request For Comments (RFC) 2547, which was superseded by RFC 4364, describes a VPN implementation of this nature which is designed to operate over an MultiProtocol Label Switching (MPLS) infrastructure. This architecture has since been extended to enable VPNs of this nature to extend over generic IP network infrastructures, as described in greater detail in U.S. patent application Ser. No. 11/935,563, filed Nov. 6, 2007, entitled “Supporting BGP Based IP-VPNs in a Routed Network”, the content of which is hereby incorporated herein by reference.

IP multicast has been developed as an efficient way of delivering content to multiple receivers on an Internet Protocol (IP) network. Many IP multicast protocols have been developed, including DVMRP, PIM-SM, PIM-SSM, PIM-DM, etc. These multicast routing protocols enable multicast trees to be built, so that receivers may be able to join the multicast and receive the multicast content in an efficient manner. Often a separate protocol, such as Internet Group Multicast Protocol (IGMP), may be used to enable receivers to join and leave particular multicast sessions. However, the actual multicast distribution tree is established and maintained using the particular multicast protocol in use by the routers on the network. Example uses of IP multicast include IP Television, videocast, video conferencing, although other uses probably exist and are likely to be developed over time.

Establishment of a Virtual Private Network (VPN) enables the physical network to be virtualized, so that the traffic may be maintained private to the subset of users and nodes that form part of the virtual network. Essentially, the VPN confines traffic so that it is not visible to nodes outside of the VPN. While this works well for unicast traffic, which is intended to be delivered to a particular network element on the network, multicast traffic is often intended to be widely distributed. Thus, if the multicast sender is part of a VPN, the VPN will generally confine distribution of the multicast so that only members of the VPN are able to receive the multicast.

For example, IETF RFC 2547/4364 enables Virtual Routing and Forwarding (VRF) instances to be created and associated with a particular VPN. The VRFs have route import/export policies that limit what network elements are visible on the network. If a multicast is implemented within the VPN, any receivers that are connected to a VRF that is part of the VPN will be able to subscribe to the multicast. However, the VPN will prevent receivers that are outside of the VPN from subscribing to the multicast. Thus, separate multicast distribution trees may need to be built for each VPN in use on the network, which may cause multiple copies of the multicast content to need to be delivered on the network.

There are times that it would be advantageous to enable receivers in different VPNs to subscribe to the same IP multicast. For example, a large enterprise may have different VPNs for different departments, such as a VPN for accounting, a VPN for human resources, and a VPN for engineering. The president of the company may want to stream a video presentation to all employees of the enterprise. In this instance, rather than streaming the video presentation separately within each of these three VPNs, it would be advantageous to add all users to the same IP multicast. Likewise, in a cable TV scenario, a cable TV provider may implement a separate VRF for each customer and, hence, have essentially a separate VPN established for each of its customers. The cable TV provider will then provide video content to each customer via the customer's VRF, i.e. within the customer's VPN, so that each customer can only have access to the content it has paid for. However, where there are multiple customers supported by a given PE network element that are currently watching the same channel, it would be advantageous to enable the multiple customers to join the same IP multicast distribution tree so that a single copy of the IP multicast may be provided to the PE and distributed by the PE to each of the subscribers, rather than having separate copies of the data transmitted on each of the separate VPNs.

Unfortunately, since VRFs in different VPNs do not share routing information with each other, receivers in the separate VPNS will not be allowed to be part of the same multicast distribution tree branch. Although the receivers could be moved to be part of the same VPN, this takes away control from the network operator who, for other reasons, may prefer to segregate users into different VPNs.

Thus, it would be advantageous to enable VRFs in different VPNs that are supported by the same PE node to communicate with each other. One way to do this is to configure an IP interface on an external port for each such VRF, run PIM or other multicast protocol on this external IP interface, and manually connect the ports with external cables. This enables the VRFs to be tricked into believing that they are independent routers, which enables the multicast to be transmitted between VRFs in different VPNs and, accordingly, enables all of the receivers to be part of the same VPN as the sender. While this solution thus enables a IP multicast to be transmitted between VPNs, it requires an operator to physically plug wires into ports on the PE node. Additionally, it uses external ports which may be needed to connect with other physical links on the network. Accordingly, it would be advantageous to provide another way of enabling receivers in different VPNs to subscribe to the same IP multicast to be distributed to receivers in multiple VPNs.

### SUMMARY OF THE INVENTION

A method and apparatus for enabling multicast route leaking between VRFs in different VPNs enables receivers in different VPNs to subscribe to the IP multicast and enables an efficient IP multicast distribution tree to be built including subscribers in different VPNs. According to an embodiment, a multicast tree may be built for an IP multicast within a primary VPN to be used to transmit multicast packets within the VPN. The primary VPN may be a VPN including the IP multicast source or may be another VPN. Where VRFs from other VPNs are co-located on PE nodes that have membership in the IP multicast on the primary VPN, rather than implement a separate branch of the tree within their own VPN, the VRFs may implement multicast route leaking to enable local distribution within the PE node from the primary VPN to all other VPNs with attached receivers on the node. This enables a more efficient multicast tree to be built in which local distribution of IP multicast information may occur between VPNs within the PE nodes on the network.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example communication network showing establishment of multiple VPNs on the communication network;

FIG. 2 shows distribution of multicast data within the separate VPNs on the communication network of FIG. 1;

FIGS. 3 and 4 are functional block diagrams of a portion of a communication network showing distribution of multicast data between VPNs where IP multicast route leaking has been enabled on the network elements;

FIG. 5 shows a flow chart of an example process that may be used to enable IP multicast route leaking between VRFs; and

FIG. 6 is a flow chart showing implementation of the process shown in FIG. 5 as it applies to the example communication network shown in FIG. 3.

### DETAILED DESCRIPTION

Enterprise consolidation and security considerations are drivers that demand that networks be virtualized. Virtualization of a network enables a virtual network to be created over the physical network so that traffic may be maintained private to the subset of users and nodes that form part of the virtual network. Layer 2 (i.e. Ethernet Virtual Local Area Network VLAN) and Layer 3 (Internet Protocol) based VPNs are functionalities that support network virtualization. There are many types of VPNs, such as MPLS based VPNs (established using IETF RFC 4364/2547), Virtual Private LAN Service (VPLS), Pseudowire, and IP-Security (IP-SEC) based VPNs. Other types of VPNs exist as well and this list is not intended to be exhaustive. Use of VPNs enables traffic to be segregated, so that particular traffic may be provided only to selected receivers that are associated with a particular VPN.

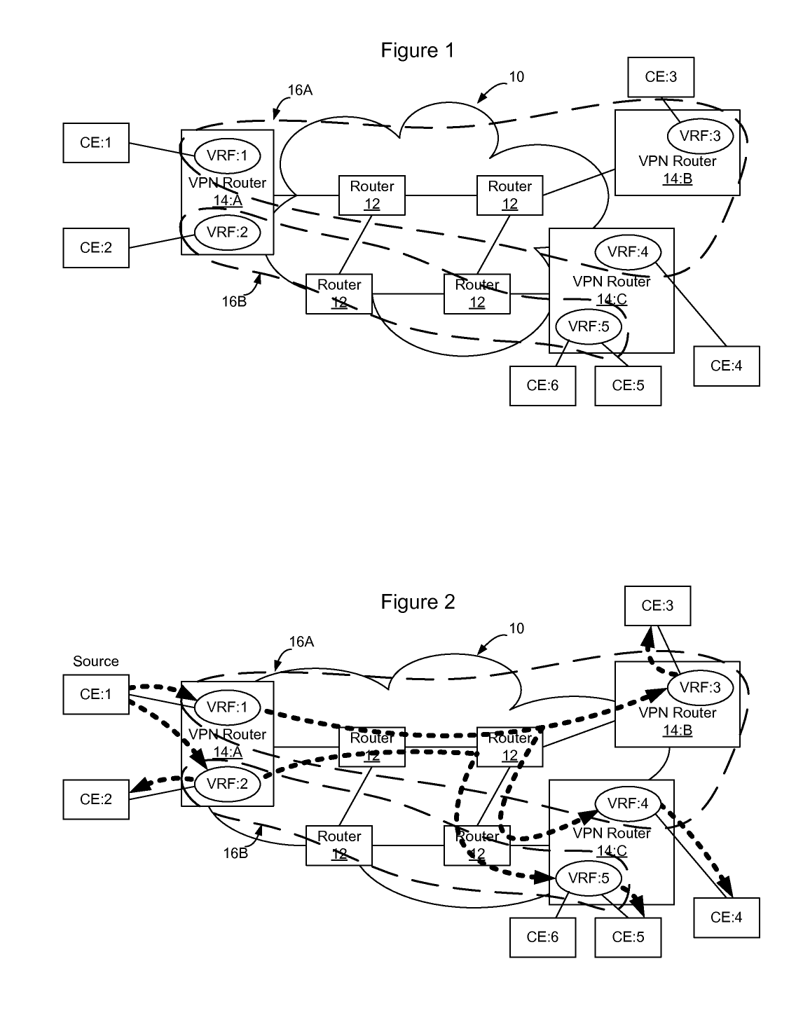

FIG. 1 shows an example communication network 10. In the communication network 10, routers 12 interconnect VPN routers 14. The VPN routers support Virtual Routing and Forwarding (VRF) instances created using RFC 4364/2547 or another VPN protocol. As noted above, there are several different types of VPNs that utilize VRFs to control routing information, and the invention is not limited to one particular such implementation. The network 10 may be an Internet Protocol (IP) network, Multi-Protocol Label Switching (MPLS) network, or another type of network.

In FIG. 1, there are two separate VPNs that have been defined on the network. A first VPN 16A includes VRF:1 on VPN Router 14:A, which provides VPN connectivity to Customer Edge (CE) CE:1; a second VRF:3 on VPN router 14:B, which provides VPN connectivity to CE:3; and a third VRF:4 on VPN router 14:C, that provides connectivity to CE:4. The second VPN shown on FIG. 1 includes VRF:2 and VRF:5. Each of these VRFs provides VPN connectivity to one or more CE devices. The CE devices may be computers, servers, LAN gateways, or other devices that require VPN services on network 10.

The VPNs shown in FIG. 1, and hence the VRFs that are implemented as part of the VPNs, are configured by a network administrator in a normal manner. Where the underlying network 10 is implemented using an MPLS architecture, the VRFs may be configured using RFC 2547/4364. Where the underlying network 10 is an IP network, the VRFs may exchange service IP addresses to enable VPN traffic to be IP encapsulated for transportation on the network. Unicast traffic within the VPN is thus handled in a normal manner and optionally unicast route leaking may be implemented in a conventional manner to enable unicast traffic to be exchanged between the VPNs as desired.

Although multiple VPNs work well in connection with separating traffic on the network, there are times where separating traffic in this manner does not result in optimal traffic patterns on the network. FIG. 2 shows an example multicast scenario where a particular multicast source (CE:1) is located in one VPN (VPN 16A), and the multicast receivers are located in both VPN 16A and VPN 16B. Specifically, in the example shown in FIG. 2 the multicast source CE:1 and multicast receivers CE:3 and CE:4 are located in VPN 16:A, and multicast receivers CE:2 and CE:5 are located in VPN:16B.

As shown in FIG. 2, to enable the multicast to be transmitted to receivers in the separate VPNs, source CE:1 will need to transmit a separate copy of the multicast within each of the VPNs. A separate multicast distribution tree will be built within each VPN so that the multicast can be distributed within each VPN. Accordingly, in this example, source CE:1 will transmit a copy of the multicast packets to VRF:1 which will pass the packets over the VPN 16A to VRF:3 and VRF:4. Likewise, source CE:1 will transmit a copy of the multicast packets to VRF:2 which will distribute the multicast within VPN 16B to receiver CE:2 and also pass a copy of the multicast packets out over the network to VRF:5. Since both VRF:4 and VRF:5 are implemented on the same VPN router 14:C, this will cause two copies of the multicast packets to be passed over the network from the same source (VPN router 14:A) to the same destination (VPN Router 14:C). Hence, this results in an inefficient use of network bandwidth.

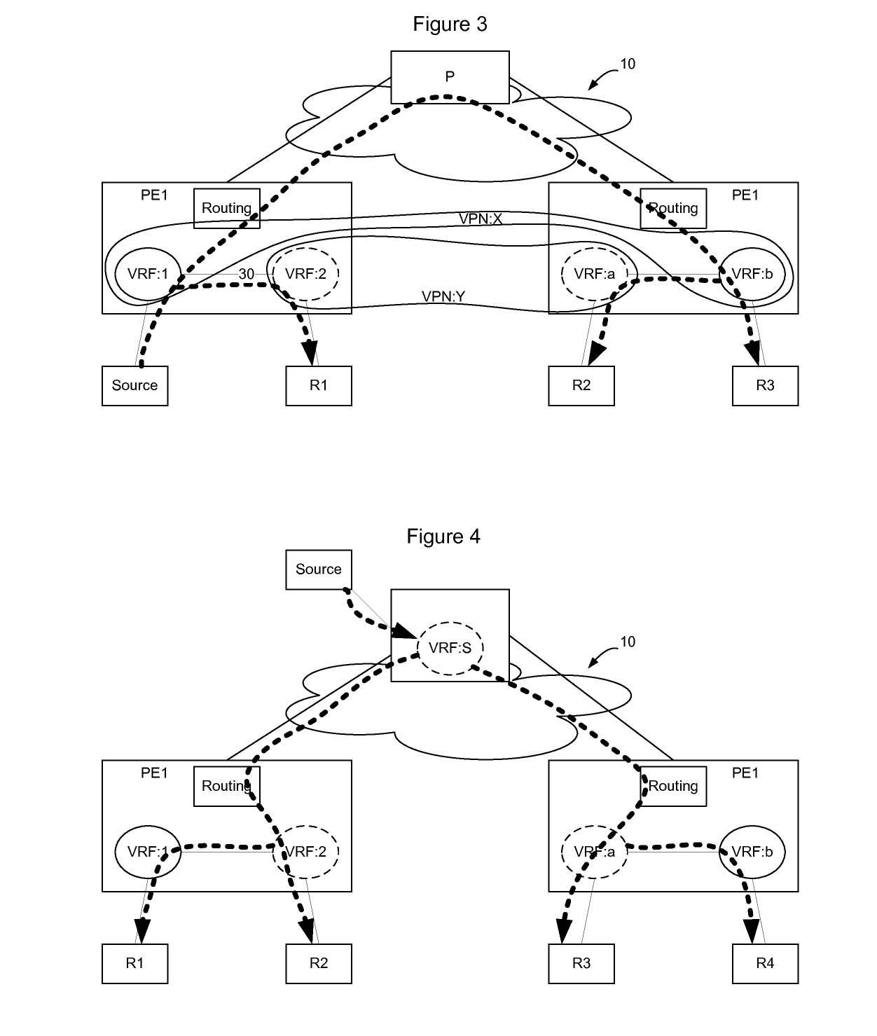

FIGS. 3 and 4 show alternative IP multicast distribution patterns where VRFs from different VPNs are able to leak routes between each other, so that IP multicast trees may be built to include VRFs from multiple VPNs. In the embodiment shown in FIGS. 3 and 4, VRF:1 and VRF:b are in VPN:X and VRF:2 and VRF:a are in second VPN:Y. However, route leaking has been enabled between the VRFs within the Provider Edge (PE) network elements so that VRFs from one VPN can join IP multicast implemented in another VPN, as long as the other VPN has a VRF instantiated on the same VPN router. Note, in this context, that multicast route leaking only occurs within a particular network element and does not occur between network elements. Thus, VRF:2 in VPN:Y can leak multicast routes to VRF:1 in VPN:X but cannot leak multicast routes to VRF:b in VPN:X since VRF:b is physically located on another network element.

In the example shown in FIG. 3, an IP multicast has been established in VPN:X. This VRF will be referred to as the primary VPN. VRFs outside the primary VPN leak routes into a VRF associated with the primary VPN so that multicast content being distributed within the primary VPN may be copied to the VRFs outside the primary VPN. In this example, the IP multicast source is attached to VRF:1 and receiver R3 is attached to VRF:b. VRF:2 has been configured to participate in the IP multicast so that receiver R1 may also receive a copy of the IP multicast even though receiver R1 is associated with VRF:2 which is part of another VPN. Likewise VRF:a has been configured to perform multicast route leaking to enable VRF:a to become part of the IP multicast, so that VRF:b will transmit a copy of the IP multicast to VRF:a even though VRF:a is not part of VPN:X. Accordingly, R2 may participate in the IP multicast occurring on a different VPN than the VPN to which it is attached.

FIG. 4 is similar to FIG. 3 except that the IP multicast source is not part of either VPN. in this instance, the IP multicast source may transmit IP multicast packets to a VRF associated with one of the VPNs and a multicast tree may be built within that VPN. Where VRFs from other VPNs are co-located on PE nodes that have membership in the IP multicast, rather than implement a separate branch of the tree within their own VPN, the VRFs may implement multicast route leaking to enable local distribution within the PE node to all VPNs with attached receivers. Accordingly a more efficient multicast tree may be built in which local distribution of IP multicast information may occur between VPNs within the PE nodes on the network.

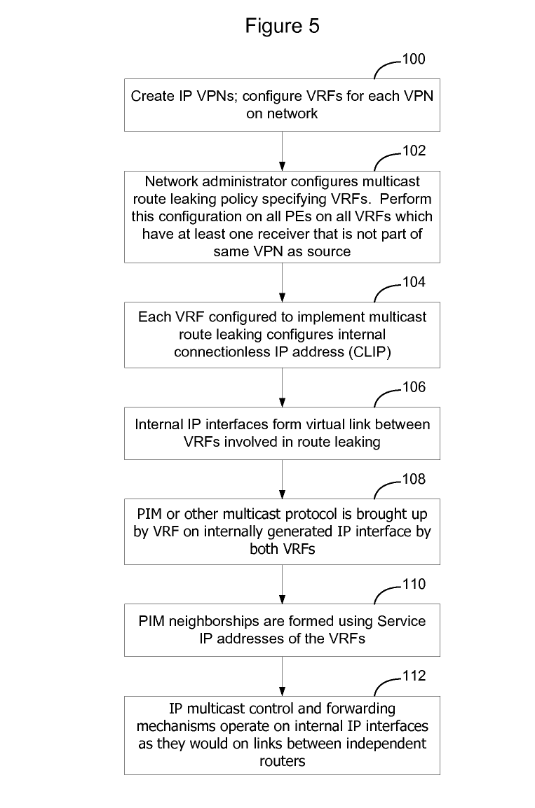

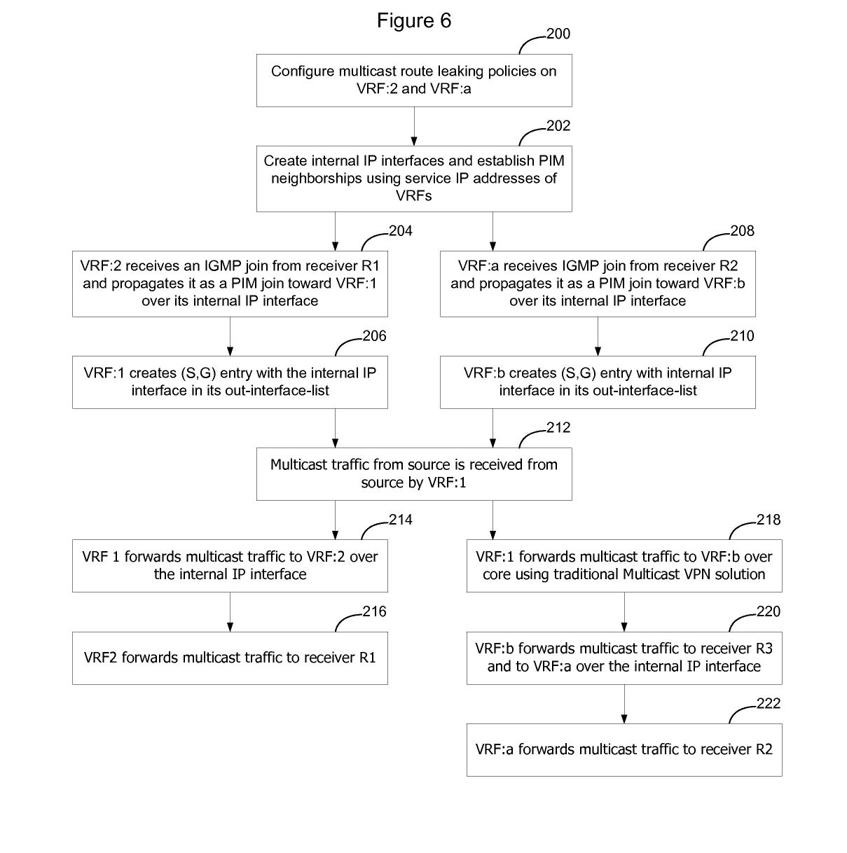

FIG. 5 shows an example process that may be used to enable route leaking between VRFs so that VRFs from different VPNs may participate in the same IP multicast according to an embodiment of the invention. FIG. 6 explains the embodiment of FIG. 5 in greater detail with reference to the example network shown in FIG. 3.

As shown in FIG. 5, in one embodiment, IP VPNs are created in a normal manner, and VRFs are configured for each VPN on the network (100). As noted above, where the VPNs are implemented using normal 2547/4364, this would entail creating the VRFs and causing the VRFs to exchange MPLS labels to be used to encapsulate traffic on the VPN. Where an IP VPN is being used, the VRFs will exchange IP service addresses that will be used to create an IP header that will then be used to transport VPN traffic on the network. The IP header may be used to encapsulate customer traffic using IP encapsulation techniques or, where the customer traffic already has an IP header, the IP header may be used to perform IP in IP encapsulation of the customer traffic. Other types of VPNs that use VRFs may likewise be used, as the IP multicast route leaking process described herein may be used with any VPN that uses VRFs to control distribution of traffic on the VPN. Thus, normal VRF configuration processes may be used to set up the VPNs on the network and the invention is not limited to one particular type of VPN.

The network administrator will then configure multicast route leaking policy specifying VRFs that are allowed to perform multicast route leaking within a particular Provider Edge (PE) network element (102). The network administrator will configure each VRF on each PE that has at least one receiver that is not part of the same VPN as the source. The multicast route leaking policy that is configured on the VRFs may be specific to a particular multicast source and multicast group (S,G), may be specific to a particular multicast source regardless of multicast group (S,*), specific to a particular multicast group regardless of source (*,G) or universal (*,*). Other policies may be implemented as well. Likewise, multiple policies may be implemented on a given VRF to enable the VRF to perform route leaking, and hence obtain multicast packets, from multiple multicasts.

According to an embodiment of the invention, each VRF that is configured to implement multicast route leaking will configure an internal connectionless IP address (CLIP) (104). These internal IP interfaces will be used to form virtual links between the VRFs involved in route leaking (106).

Each configured VRF will then bring up Protocol Independent Multicast (PIM) or another multicast routing protocol in use on the network on this internal interface (108). The VRFs will exchange hello messages to form PIM neighborships using their service IP addresses (110). Thus, each VRF will add the neighboring VRF service IP address to their forwarding database as being reachable via the IP address associated with the internal interface. Accordingly, when IP multicast packets are received, the VRFs may include their neighboring VRFs within the IP multicast by transmitting the packets on the internal interface (108).

Each VRF will implement multicast control and forwarding mechanisms on the internal IP interfaces in the same way that they would on normal interfaces (112). Thus, as receivers join the multicast, a VRF will forward the join message on the internal interface to the VRF associated with the VPN that is handling the IP multicast. That VRF will add the internal interface to its distribution list so that IP packets associated with the IP multicast will be transmitted over the internal interface to the other VRF. Hence, VRFs from multiple VPNs may particulate in a given IP multicast.

In the above description and in the following example, a particular multicast routing protocol (PIM) was used as an example to help explain how an embodiment of the invention may be implemented. The invention is not limited to this particular multicast routing protocol, however, and it should be understood that many different types of multicast routing protocols, such as PIM-SM (Protocol Independent Multicast-Sparse Mode), PIM-SSM (Protocol Independent Multicast-Single Sender Mode), PIM-DM (Protocol Independent Multicast-Dense Mode), Distance Vector Multicast Routing Protocol (DVMRP), or another multicast routing protocol may be used.

FIG. 6 is a flow chart explaining how multicast route leaking may be implemented in connection with FIG. 3 to enable IP multicast packets flowing on VPN:X to be transmitted to receivers R:1 and R:2 in VPN:Y.

As shown in FIG. 6, the network administrator will need to configure multicast route leaking policies on VRF:2 on PE:1 and on VRF:a on PE:2 (200). Configuring multicast route leaking policies on these VRFs enables the VRFs to communicate with the VRF in the VPN that is handling the IP multicast so that the VRF may be added to the IP multicast distribution tree. Note, that the multicast route leaking policy is required to be configured on the VRF that would like to receive a copy of the IP multicast, so that its receivers can issue join/prune commands to join/leave the IP multicast.

The route leaking policy that is configured on a particular VRF may be specific to a particular multicast or may be a more general policy. In a multicast context, route leaking is generally from the receiver toward the transmitter, so that in one embodiment the administrator is only required to configure VRF:2 to perform multicast route leaking to VRF:1 and is only required to configure VRF:a to perform multicast route leaking toward VRF:b. This allows receivers attached to VRF:2 and VRF:a to join this multicast in VRF:1 and VRF:b. In another embodiment, the network administrator may also be required to configure VRF:1 and VRF:b to accept routes from other VRFs outside of the VPN. Hence, in this alternative embodiment, the network administrator would be required to configure VRF:1 to accept multicast route leaking from VRF:2 and be required to configure VRF:b to accept multicast routes from VRF:a.

Once the VRFs have been configured with the appropriate IP multicast route leaking policies, each VRF will bring up an Internal IP interface (202). The internal connectionless IP interface (CLIP) is identified by reference numeral 30 in FIG. 3. For example, the connectionless IP interface from VRF:1 to VRF:2 may have an IP address of 127.0.1.2. In the other direction the IP interface may have an address of 127.0.2.1. Of course, these example IP interface addresses are merely intended to be examples as other interface addresses may of course be used.

Once the IP interfaces have been brought up, each VRF will enable the multicast protocol on that interface. Thus, in a PIM context, the VRF:2 will enable PIM on IP interface 127.0.2.1 to enable a PIM neighborship to be established with VRF:1 on that interface. Likewise, VRF:1 will enable PIM on IP interface 127.0.1.2 to enable a PIM neighborship to be established with VRF:2. As part of establishing the PIM neighborships, the VRFs will exchange service IP addresses so that they are able to learn IP reachability of each other on their CLIP interface.

In this example, it will be assumed that receivers R1 and R2 would like to join the multicast that is being distributed through VPN:X. Accordingly, receiver R:1 will send an IGMP Join message to VRF:2 and receiver R:2 will send an IGMP Join message to VRF:a. When VRF:2 receives the IGMP Join from receiver R:1, it will propagate it as a PIM join toward VRF:1 over the internal IP interface (204). Upon receipt of the PIM join by VRF:1, VRF:1 will create a Source, Group (S,G) entry with the internal IP interface in its out-interface list (206). This will enable VRF:1 to forward a copy of the IP multicast packets onto the internal IP interface to VRF:2.

Likewise, when VRF:a receives the IGMP Join from receiver R:2, it will propagate it as a PIM join toward VRF:b over its internal IP interface (208). VRF:b will create an (S,G) entry with the internal IP interface in its out-interface-list so copies of the IP multicast packets may be passed out the internal IP interface toward VRF:a (210).

When multicast traffic from the source is received by VRF:1 (212) VRF:1 will forward the multicast traffic to VRF:2 over the internal IP interface (214). VRF:2 will then forward the traffic to receiver R:1 (216). Likewise, VRF:1 will forward the multicast traffic to VRF:b over the core network using traditional multicast VPN solution (218). Upon receipt, VRF:b will forward the multicast traffic to all receivers in its out-interface list. Accordingly, VRF:b will forward the multicast traffic to receiver R3 and to VRF:a on its internal IP interface (220). VRF:a will then forward the multicast traffic to receiver R2.

The functions described above may be implemented as a set of program instructions that are stored in a computer readable memory and executed on one or more processors on the computer platform. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense.

What is claimed is:

1. A method of enabling multicast route leaking between a first Virtual Routing and Forwarding process (VRF) associated with a first Virtual Private Network (VPN) and a second VRF associated with a second VPN, the first VRF and second VRF being physically implemented within a given network element on a communication network, the method comprising the steps of:
configuring the first VRF to enable multicast route leaking;
configuring a first internal IP interface on the first VRF;
configuring a second internal IP interface on the second VRF;
enabling a multicast protocol on the first internal IP interface and second internal IP interface to enable the first VRF to leak multicast routes to the second VRF so that multicast traffic received by the second VRF in the second VPN may be forwarded to the first VRF in the first VPN.

2. The method of claim 1, wherein the step enabling a multicast protocol on the internal IP interface comprises establishing a multicast protocol neighborship between the first and second VRFs over their respective first and second IP interfaces.

3. The method of claim 1, wherein the internal IP interfaces are connectionless interfaces.

4. The method of claim 1, further comprising the steps of receiving, by the first VRF, a message from a first receiver requesting to join a first multicast implemented in the second VPN, and transmitting a multicast join message from the first VRF to the second VRF.

5. The method of claim 4, wherein the multicast join message is transmitted on the first internal IP interface.

6. The method of claim 4, further comprising the steps of receiving, by the second VRF, the multicast join message from the first VRF; and adding the second internal IP interface to a multicast distribution table to enable packets received that are associated with the first IP multicast to be output to the first VRF over the second internal IP interface.

7. A method of enabling first multicast to include receivers within a plurality of virtual private networks (VPNS) on a communication network, the method comprising the steps of:
establishing a multicast distribution tree for the first multicast within a primary VPN, the primary VPN having a first VRF instantiated in a first network element;
enabling a second VRF instantiated in the first network element and associated with a second VPN other than the primary VPN to leak a route to the first VRF associated with the primary VPN; and
extending the multicast distribution tree for the first multicast to extend from the first VRF associated with the primary VPN to the second VRF associated with the second VPN so that the IP multicast tree include VRFs from multiple VPNs.

8. The method of claim 7, further comprising the step of configuring a first internal IP interface on the first VRF and configuring a second IP interface on the second VFR.

9. The method of claim 8, further comprising the step of enabling a multicast protocol associated with the first multicast on both the first internal IP interface and the second IP interface.

10. The method of claim 9, further comprising the step of exchanging multicast protocol messages on the first and second internal IP interfaces to enable the first and second VRFs to become neighbors on the first and second internal IP interfaces.

11. The method of claim 10, further comprising the step of transmitting, by the first VRF to the second VRF, a first service IP address associated with the first VRF;

12. The method of claim 11, further comprising the step of adding an entry to a forwarding database, by the second VRF, that the first service IP address of the first VRF is reachable by the second internal IP address of the second VRF.

13. The method of claim 12, further comprising the step of transmitting a multicast join message on the first internal interface by the first VRF to the second VRF.

14. The method of claim 13, further comprising adding the second internal interface to a multicast distribution list for the first multicast to enable multicast packets associated with the first multicast to be transmitted over the second internal interface to the first service IP address of the first VRF.

15. A communication network, comprising:
a plurality of network elements interconnected with each other to enable IP multicast packets to traverse the network on an IP multicast distribution tree, at least some of the plurality of network elements implementing Virtual Routing and Forwarding (VRF) processes associated with a primary Virtual Private Network (VPN) to enable communications with the primary VPN to be segregated on the network, the IP multicast distribution tree being implemented within the primary VPN, at least one of the plurality of network elements implementing one of the VRF processes associated with the primary VPN containing, as a forwarding entry for the IP multicast, a service IP address of a VRF process not associated with the primary VPN.

16. The communication network of claim 15, wherein the forwarding entry will cause the VRF containing the forwarding entry to forward IP packets associated with the IP multicast to the VRF process not associated with the primary VPN to thereby enable the IP multicast to include destinations not included in the primary VPN.
